(19) United States
(12) Patent Application Publication
(10) Pub. No.: US 2025/0134115 A1
(43) Pub. Date: May 1, 2025

(54) BAKERY PREMIX POWDER

(71) Applicant: Texture Maker Enterprise Co., Ltd., New Taipei City (TW)

(72) Inventors: Yu-Chen Peng, New Taipei City (TW); Shao-Fang Hsueh, New Taipei City (TW)

(21) Appl. No.: 18/917,483

(22) Filed: Oct. 16, 2024

(30) Foreign Application Priority Data
Oct. 27, 2023 (TW) 112141199

(51) Int. Cl. A21D 2/18; A21D 2/02; A21D 10/00; A21D 13/047; A21D 13/60

(52) U.S. Cl. CPC A21D 2/186; A21D 2/02; A21D 2/181; A21D 10/005; A21D 13/047; A21D 13/60

(57) ABSTRACT

A bakery premix powder for preparing a donut-type bakery product is provided. The bakery premix powder includes starch, the starch includes hydroxypropyl starch and acetate starch, and a weight ratio of the hydroxypropyl starch to the acetate starch is ranged between 2:1 and 3:1.

### CROSS-REFERENCE TO RELATED APPLICATION

This application claims priority to Taiwan Patent Application No. 112141199, filed on Oct. 27, 2023. The entire contents of the above-mentioned patent application are incorporated herein by reference for all purposes.

### FIELD OF THE INVENTION

The present disclosure relates to a bakery premix powder, and more particularly to a bakery premix powder which provides great expansion ability and shaping effect during making a donut-type bakery product.

### BACKGROUND OF THE INVENTION

The yeast and/or leavening agent, for example, chemical leavening agent, such as baking powder, baking soda and ammonium bicarbonate, is widely used in making conventional donuts for producing gas, so as to expand the volume of the donut, make the donut fluffy and improve the appearance thereof. However, by using the yeast, other than controlling the temperatures of water and dough, it also needs to wait for the fermentation to complete. Not only the processes are complicated and time-consuming, but also the quality of donuts depends on manual experience. Therefore, the donut might develop some undesirable properties without a proper control of the making processes, for example, the donut might contain uneven sizes of holes after expansion to cause rough texture, and the flavor thereof also might become sour. On the other hand, if too much chemical leavening agent is added, the donut might have a coarse texture, lack of elasticity and cause an obvious teeth grinding feeling as tasting, and further, people who suffer from indigestion might feel discomfort after consumption.

Therefore, there is a need of providing a bakery premix powder for solving the above drawbacks.

### SUMMARY OF THE INVENTION

An object of the present disclosure is to provide a bakery premix powder which provides the required expansion for the baking product made therefrom without adding leavening agent or under a reduced amount of leavening agent.

Another object of the present disclosure is to provide a bakery premix powder which employs specific components in a specific ratio for providing great expansion ability and shaping effect for the baking product made therefrom, thereby eliminating or reducing the required amount of leavening agent.

In accordance with an aspect of the present disclosure, a bakery premix powder for preparing a donut-type bakery product is provided. The bakery premix powder includes starch, the starch includes hydroxypropyl starch and acetate starch, and a weight ratio of the hydroxypropyl starch to the acetate starch is ranged between 2:1 and 3:1.

In an embodiment, the starch is made from natural starch through chemical modification and/or chemical modification and then pregelatinization, and wherein the natural starch comprises at least one selected from the group consisting of tapioca starch, corn starch, wheat starch, potato starch, pea starch, and/or respective derivatives thereof.

In an embodiment, the bakery premix powder includes between 20 wt % to 50 wt % of modified starch and between 1 wt % to 15 wt % of pregelatinized modified starch.

In an embodiment, the hydroxypropyl starch includes hydroxypropyl modified starch, hydroxypropyl modified cross-linked starch, and/or respective pregelatinizations thereof, and the acetate starch comprises acetate modified starch, acetate modified cross-linked starch, and/or respective pregelatinizations thereof.

In an embodiment, the starch includes the hydroxypropyl modified starch and/or the pregelatinization thereof in a weight of 10-30% of the bakery premix powder, the hydroxypropyl modified cross-linked starch and/or the pregelatinization thereof in a weight of 0-20% of the bakery premix powder, the acetate modified cross-linked starch and/or the pregelatinization thereof in a weight of 4-12% of the bakery premix powder, and the acetate modified starch and/or the pregelatinization thereof in a weight of 0-8% of the bakery premix powder.

In an embodiment, the starch includes the hydroxypropyl modified starch and/or the pregelatinization thereof in a weight of 2-8% of the bakery premix powder, the hydroxypropyl modified cross-linked starch and/or the pregelatinization thereof in a weight of 0-6% of the bakery premix powder, the acetate modified cross-linked starch and/or the pregelatinization thereof in a weight of 1-4% of the bakery premix powder, and the acetate modified starch and/or the pregelatinization thereof in a weight of 0-3% of the bakery premix powder.

In an embodiment, the starch further includes oxide starch and/or starch sodium octenyl succinate.

In an embodiment, the bakery premix powder includes between 0 wt % to 3 wt % of leavening agent, and the leavening agent comprises at least one selected from the group consisting of baking powder, baking soda, ammonium bicarbonate, phosphate and tartaric acid.

In an embodiment, the bakery premix powder includes between 0 wt % and 10 wt % of rice flour, and the rice flour is made from white rice and/or brown rice of at least one selected from the group consisting of indica rice, japonica rice, glutinous rice and black rice.

In an embodiment, the bakery premix powder includes between 10 wt % to 40 wt % of flour.

In an embodiment, the bakery premix powder includes between 5 wt % to 20 wt % of sweetener, and the sweetener comprises at least one selected from the group consisting of sucrose, glucose, maltose, fructose, lactose, beet sugar, flavored syrups, honey and sugar alcohol.

In an embodiment, the bakery premix powder includes between 1 wt % to 5 wt % of seasoning.

In an embodiment, the bakery premix powder is mixed with liquid material and fat to form dough so as to make the donut-type bakery product.

In an embodiment, a heating process is employed to heat the dough, and the heating process comprises at least one selected from the group consisting of steaming, baking, frying and deep-frying.

In an embodiment, the heating process is to reach a core temperature of the dough between 50° C. and 90° C.

In an embodiment, the liquid material comprises at least one selected from the group consisting of water, egg, milk and plant milk.

In an embodiment, the fat comprises at least one selected from the group consisting of butter, ghee, margarine, corn oil, olive oil, salad oil, palm oil, coconut oil, and brown rice oil in a state of solid, liquid and/or powder.

### DETAILED DESCRIPTION OF THE PREFERRED EMBODIMENT

The present disclosure will now be described more specifically with reference to the following embodiments. It is to be noted that the following descriptions of preferred embodiments of this disclosure are presented herein for purpose of illustration and description only. It is not intended to be exhaustive or to be limited to the precise form disclosed.

The present disclosure provides a bakery premix powder which mainly includes starch, flour, sweetener and seasoning. The starch includes chemically modified raw starch and pregelatinized starch (alpha starch), namely, the starch is composed of modified starch and pregelatinized modified starch. The bakery premix powder is provided for preparing a donut-type bakery product by mixing with liquid material and fat to form dough and then heating the dough. Particularly, no leavening agent or only an extremely low amount of leavening agent, compared with the amount used in the general recipe for preparing the donut, is added in the bakery premix powder of the present disclosure, and the expansion ability and shaping effect of the prepared donut-type bakery product are comparable to or even better than those of the donut prepared by the general recipe.

The bakery premix powder of present disclosure includes between 20 wt % to 50 wt % of the modified starch, between 1wt % to 15 wt % of the pregelatinized modified starch, between 10 wt % to 40 wt % of the flour, between 5 wt % to 20 wt % of the sweetener, and between 1 wt % to 5 wt % of the seasoning. Moreover, the bakery premix powder also can include other powdery raw materials, such as between 0-10 wt % of rice flour. The extremely low amount of leavening agent is 0-3 wt %.

The modified starch and the pregelatinized modified starch are prepared from natural starch. The natural starch refers to tapioca starch, corn starch, wheat starch, potato starch, pea starch, and/or respective derivatives thereof, but not limited thereto. The modified starch is obtained by chemically modifying the natural starch as described above, and the pregelatinized modified starch is obtained by chemically modifying the natural starch and then pregelatinizing thereof.

The rice flour is made from white rice and/or brown rice, such as indica rice, japonica rice, glutinous rice and/or black rice, but not limited thereto.

The sweetener refers to various kinds of artificial and/or natural sweeteners that are often used in the bakery product, such as sucrose, glucose, maltose, fructose, lactose, beet sugar, flavored syrups, honey and/or sugar alcohol, but not limited thereto.

The seasoning refers to various kinds of seasonings that are often used in the bakery product, such as salt and milk powder, but not limited thereto.

The leavening agent refers to various kinds of leavening agents that are often used in the bakery product for producing gas when mixing with water or being heated, such as baking powder, baking soda, ammonium bicarbonate, phosphate and tartaric acid, but not limited thereto.

When making the dough, between 25 wt % to 65 wt % of the bakery premix powder is mixed with between 25 wt % to 45 wt % of liquid material and between 10 wt % to 30 wt % of fat. The obtained dough is heated through steaming, baking, frying and/or deep-frying to form the donut-type bakery product. In one embodiment, the heating process is to reach a core temperature of the dough between 50° C. and 90° C. In a preferable embodiment, the heating process is to reach the core temperature of the dough between 55° C. and 70° C.

The liquid material refers to, for example, water, egg, milk and/or plant milk, which are often used in the bakery product, but not limited thereto.

The fat refers to various kinds of animal and/or vegetable fats in various states that are often used in the bakery product, such as butter, ghee, margarine, corn oil, olive oil, salad oil, palm oil, coconut oil, and brown rice oil, in a state of solid, liquid and/or powder, but not limited thereto.

Furthermore, the composition of the bakery premix powder of the present disclosure is particularly adjusted for achieving the purpose of eliminating the usage of leavening agent or reducing the amount of leavening agent.

Based on experimental results, it is found that when the starch contained in the bakery premix powder includes hydroxypropyl starch and acetate starch, and a ratio of hydroxypropyl starch to acetate starch ranged between 2:1 and 3:1, the expansion ability and shaping effect of the donut-type bakery product made therefrom are comparable to and better than those of the donut formed by the general recipe. In a preferable embodiment, the specific ratio of hydroxypropyl starch to acetate starch can be further ranged between 2.2:1 and 2.5:1.

Hydroxypropyl starch is obtained through modifying starch with methoxy group or epoxyethane (cyclopropane), and acetate starch is obtained through modifying starch with inorganic or organic acids. The hydrophilic groups in the hydroxypropyl starch and the acetate starch can absorb water molecular in the starch, and thus, on one hand, during the heating process, the steam stress within the dough can be increased to assist expansion and gelatinization, and on the other hand, the dough can be stably maintained at high viscosity and consistency. Consequently, when the bakery premix powder of the present disclosure is mixed with liquid material and fat to make dough, the starch containing the hydroxypropyl starch and the acetate starch absorbs water molecular first, and when the core temperature of dough reaches the appropriate temperature during heating process, such as reach to 50° C. to 90° C., the water in the dough transforms into water vapor due to the heat so as to generate an outwardly expanding force, and also, the gelatinization of the starch starts. At this time, through the cooperation between the hydroxypropyl starch and the acetate starch, in addition to the high expansion ability, the stably maintained high viscosity and consistency also facilitate to effectively catch the water vapor in dough and to confine the outward expansion, thereby achieving the required expansion ability and shaping effect at the same time. That is, in the bakery premix powder of the present disclosure, the starch itself provides the expansion ability for the dough, and since the expansion regularity thereof is better than utilizing the leavening agent, when utilizing the bakery premix powder of the present disclosure to prepare the donut-type bakery product, a good shaped donut-type bakery product can be made by eliminating the addition of leavening agent or adding an extremely low amount of leavening agent, and by omitting the conventional complicated processes of fermentation and shaping.

More specifically, through utilizing the hydroxypropyl starch and the acetate starch in a specific ratio therebetween, the bakery premix powder of the present disclosure can effectively achieve the prompt and full expansion during the heating process and provide the great shape of the donut-type bakery product. The possible reasons causing the undesirable shaping of the donut-type bakery product, such as, over expansion, insufficient expansion and/or uneven expansion, all can be avoided.

In other words, when preparing the donut-type bakery product with the bakery premix powder of the present disclosure, it only needs to mix the bakery premix powder with liquid material and fat in a fixed ratio to form the dough, make the dough into a desired shape, and then directly perform the heating process, for example, the dough can be directly baked in the oven after molding. That is, the shaping, fermentation and proofing processes all can be omitted, thereby significantly simplifying the baking procedure and reducing the processing time, which is helpful to the commercialization and popularization of product.

The adopted hydroxypropyl starch can include hydroxypropyl modified starch, hydroxypropyl modified cross-linked starch, and/or respective pregelatinizations thereof. The adopted acetate starch can include acetate modified starch, acetate modified cross-linked starch, and/or respective pregelatinizations thereof. As mentioned above, the hydroxypropyl starch and the acetate starch can be made from various kinds of natural starch, including tapioca starch, corn starch, wheat starch, potato starch, pea starch, and/or respective derivatives thereof, but not limited thereto. The hydroxypropyl starch and the acetate starch are obtained through chemically modifying the natural starch and/or through chemically modifying and then pregelatinizing the natural starch.

In one embodiment, in the bakery premix powder of the present disclosure, the contained starch includes hydroxypropyl modified starch and/or pregelatinization thereof in a weight of 10-30% of the bakery premix powder, hydroxypropyl modified cross-linked starch and/or pregelatinization thereof in a weight of 0-20% of the bakery premix powder, acetate modified starch and/or pregelatinization thereof in a weight of 0-8% of the bakery premix powder, and acetate modified cross-linked starch and/or pregelatinization thereof in a weight of 4-12% of the bakery premix powder. Alternatively, in the bakery premix powder of the present disclosure, the contained starch includes hydroxypropyl modified starch and/or pregelatinization thereof in a weight of 10-30% of the bakery premix powder, hydroxypropyl modified cross-linked starch and/or pregelatinization thereof in a weight of 0.01-20% of the bakery premix powder, acetate modified starch and/or pregelatinization thereof in a weight of 0.01-8% of the bakery premix powder, and acetate modified cross-linked starch and/or pregelatinization thereof in a weight of 4-12% of the bakery premix powder. Moreover, as needed, the bakery premix powder can further include rice flour in a weight of 0-10% of the bakery premix powder and leavening agent in a weight of 0-3% of the bakery premix powder, and also flour, sweetener and seasoning. Alternatively, the bakery premix powder can further include rice flour in a weight of 0.01-10% of the bakery premix powder and leavening agent in a weight of 0.01-3% of the bakery premix powder, and also flour, sweetener and seasoning. Then, after the dough is formed and heated, the expansion of the donut-type bakery product can reach 1-1.5 times the volume of the dough with complete appearance and soft and chewy texture.

In one embodiment, in the bakery premix powder of the present disclosure, the contained starch includes hydroxypropyl modified starch and/or pregelatinization thereof in a weight of 2-8% of the bakery premix powder, hydroxypropyl modified cross-linked starch and/or pregelatinization thereof in a weight of 0-6% of the bakery premix powder, acetate modified starch and/or pregelatinization thereof in a weight of 0-3% of the bakery premix powder, and acetate modified cross-linked starch and/or pregelatinization thereof in a weight of 1-4% of the bakery premix powder. Alternatively, in the bakery premix powder of the present disclosure, the contained starch includes hydroxypropyl modified starch and/or pregelatinization thereof in a weight of 2-8% of the bakery premix powder, hydroxypropyl modified cross-linked starch and/or pregelatinization thereof in a weight of 0.01-6% of the bakery premix powder, acetate modified starch and/or pregelatinization thereof in a weight of 0.01-3% of the bakery premix powder, and acetate modified cross-linked starch and/or pregelatinization thereof in a weight of 1-4% of the bakery premix powder. Moreover, as needed, the bakery premix powder can further include rice flour in a weight of 0-10% of the bakery premix powder and leavening agent in a weight of 0-3% of the bakery premix powder, and also flour, sweetener and seasoning. Alternatively, the bakery premix powder can further include rice flour in a weight of 0.01-10% of the bakery premix powder and leavening agent in a weight of 0.01-3% of the bakery premix powder, and also flour, sweetener and seasoning. Then, after the dough is formed and heated, the expansion of the donut-type bakery product can reach more than 2 times the volume of the dough with complete appearance and soft and chewy texture.

Other than the hydroxypropyl starch and the acetate starch, the starch can further includes oxidized starch and/or starch sodium octenyl succinate, which can be obtained from the natural starch through chemical modification and/or chemical modification and then pregelatinization. In other embodiment, other kinds of starches also can be included according to the practical requirements without limitation.

In conclusion, the present disclosure provides a bakery premix powder which achieves the purpose of eliminating or reducing the amount of leavening agent as preparing the donut-type bakery product through employing hydroxypropyl starch and acetate starch in a specific ratio. The dough made from the bakery premix powder has great expansion ability and expansion regularity, so that the expansion and appearance of the donut-type bakery product can be directly completed during the heating process without fermentation and shaping, and the finished donut-type bakery product has soft and chewy texture.

While the disclosure has been described in terms of what is presently considered to be the most practical and preferred embodiments, it is to be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A bakery premix powder for preparing a donut-type bakery product, the bakery premix powder comprising starch, the starch comprising hydroxypropyl starch and acetate starch, wherein a weight ratio of the hydroxypropyl starch to the acetate starch is ranged between 2:1 and 3:1.

2. The bakery premix powder according to claim 1, wherein the starch is made from natural starch through chemical modification and/or chemical modification and then pregelatinization, and wherein the natural starch comprises at least one selected from the group consisting of tapioca starch, corn starch, wheat starch, potato starch, pea starch, and/or respective derivatives thereof.

3. The bakery premix powder according to claim 2, wherein the bakery premix powder comprises between 20 wt % to 50 wt % of modified starch and between 1 wt % to 15 wt % of pregelatinized modified starch.

4. The bakery premix powder according to claim 1, wherein the hydroxypropyl starch comprises hydroxypropyl modified starch, hydroxypropyl modified cross-linked starch, and/or respective pregelatinizations thereof, and the acetate starch comprises acetate modified starch, acetate modified cross-linked starch, and/or respective pregelatinizations thereof.

5. The bakery premix powder according to claim 4, wherein the starch comprises the hydroxypropyl modified starch and/or the pregelatinization thereof in a weight of 10-30% of the bakery premix powder, the hydroxypropyl modified cross-linked starch and/or the pregelatinization thereof in a weight of 0-20% of the bakery premix powder, the acetate modified cross-linked starch and/or the pregelatinization thereof in a weight of 4-12% of the bakery premix powder, and the acetate modified starch and/or the pregelatinization thereof in a weight of 0-8% of the bakery premix powder.

6. The bakery premix powder according to claim 4, wherein the starch comprises the hydroxypropyl modified starch and/or the pregelatinization thereof in a weight of 2-8% of the bakery premix powder, the hydroxypropyl modified cross-linked starch and/or the pregelatinization thereof in a weight of 0-6% of the bakery premix powder, the acetate modified cross-linked starch and/or the pregelatinization thereof in a weight of 1-4% of the bakery premix powder, and the acetate modified starch and/or the pregelatinization thereof in a weight of 0-3% of the bakery premix powder.

7. The bakery premix powder according to claim 1, wherein the starch further comprises oxide starch and/or starch sodium octenyl succinate.

8. The bakery premix powder according to claim 1, wherein the bakery premix powder comprises between 0 wt % to 3 wt % of leavening agent, and the leavening agent comprises at least one selected from the group consisting of baking powder, baking soda, ammonium bicarbonate, phosphate and tartaric acid.

9. The bakery premix powder according to claim 1, wherein the bakery premix powder comprises between 0 wt % and 10 wt % of rice flour, and the rice flour is made from white rice and/or brown rice of at least one selected from the group consisting of indica rice, japonica rice, glutinous rice and black rice.

10. The bakery premix powder according to claim 1, wherein the bakery premix powder comprises between 10 wt % to 40 wt % of flour.

11. The bakery premix powder according to claim 1, wherein the bakery premix powder comprises between 5 wt % to 20 wt % of sweetener, and the sweetener comprises at least one selected from the group consisting of sucrose, glucose, maltose, fructose, lactose, beet sugar, flavored syrups, honey and sugar alcohol.

12. The bakery premix powder according to claim 1, wherein the bakery premix powder comprises between 1 wt % to 5 wt % of seasoning.

13. The bakery premix powder according to claim 1, wherein the bakery premix powder is mixed with liquid material and fat to form dough so as to make the donut-type bakery product.

14. The bakery premix powder according to claim 13, wherein a heating process is employed to heat the dough, and the heating process comprises at least one selected from the group consisting of steaming, baking, frying and deep-frying.

15. The bakery premix powder according to claim 14, wherein the heating process is to reach a core temperature of the dough between 50° C. and 90° C.

16. The bakery premix powder according to claim 13, wherein the liquid material comprises at least one selected from the group consisting of water, egg, milk and plant milk.

17. The bakery premix powder according to claim 13, wherein the fat comprises at least one selected from the group consisting of butter, ghee, margarine, corn oil, olive oil, salad oil, palm oil, coconut oil, and brown rice oil in a state of solid, liquid and/or powder.
